(19) United States
(12) Patent Application Publication
(10) Pub. No.: US 2012/0296809 A1
(43) Pub. Date: Nov. 22, 2012

(54) TRACKING DONATED PORTION OF TRANSACTION

(75) Inventor: Erik Stephen Ross, Charlotte, NC (US)

(73) Assignee: BANK OF AMERICA CORPORATION, Charlotte, NC (US)

(21) Appl. No.: 13/109,565

(22) Filed: May 17, 2011

(51) Int. Cl. G06Q 40/00

(52) U.S. Cl. 705/39

(57) ABSTRACT

A method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules and tracking the transaction amount and the donation resulting from the use of the affinity account. In some embodiments, tracking includes storing information regarding the transaction including an amount of the transaction and storing information regarding the donation including an amount of the donation. The method also includes communicating some or all the stored information regarding the donation to the customer.

### FIELD

In general, embodiments of the invention relate to systems for tracking a donated portion of a transaction. More specifically, embodiments of the invention relate to systems for tracking a donated portion of a transaction resulting from the use of an affinity account and communicating information regarding the donation to a customer.

### BACKGROUND

Recently, the advent of rewards programs associated with banking accounts such as debit and/or credit accounts has provided incentive for customers of financial institutions to open such accounts associated with such rewards programs. Likewise, affinity programs, such as a program directed to providing a donation to a charitable organization of the customer's choice have been implemented and associated with banking accounts in order to incentivize the customer to open and maintain such accounts. In other instances, affinity programs support organizations or associations not necessarily characterized as charitable organizations such as professional associations, governments or municipalities such as counties or cities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, initiating, in the event the transaction amount justifies doing so in view of the account rules, a donation according to the account rules, and tracking the transaction amount or the donation resulting from the use of the affinity account.

In some embodiments, the tracking the donation comprises storing information regarding the donation. In some such embodiments, storing information regarding the donation comprises storing an amount of the donation. In some such embodiments, storing information regarding the donation comprises storing a recipient of the donation. In some such embodiments, storing information regarding the donation comprises storing a date and time of the donation. In some such embodiments, the method also includes communicating some or all the stored information regarding the donation to the customer.

In some embodiments, the method includes communicating information regarding the donation to the customer. In some embodiments, the method includes communicating information regarding the donation to a social network of the customer. In some such embodiments, the method also includes providing a collaboration network comprising one or more users and the customer, the collaboration network configured to provide the one or more users and the customer with an opportunity to collaborate with regard to a common affinity goal, and wherein communicating information regarding the donation to a social network of the customer comprises communicating information regarding the donation to the collaboration network.

In some embodiments, the method includes initiating a second donation in addition to the donation as an incentive for the customer to use the affinity account and communicating information regarding the second donation to the customer. In some such embodiments, the method also includes communicating an offer for an incentive donation in the event the customer performs according to the offer. In some such embodiments, communicating an offer comprises communicating an offer for the customer to purchase specific goods or services. In other such embodiments, communicating an offer comprises communicating an offer for the customer to purchase goods or services from a specific merchant.

In some embodiments, communicating information regarding the donation to the customer comprises communicating an offer for an incentive donation in the event the customer performs according to the offer. In some embodiments, tracking the transaction amount comprises tracking two or more transaction amounts, determining that the two or more transaction amounts surpass a predetermined threshold, and the method also includes initiating the donation according to the account rules and based at least in part on the two or more transaction amounts, in combination, surpassing the predetermined threshold. In some embodiments, tracking the transaction amount comprises tracking the transaction amount in view of a predetermined threshold for initiating a donation and communicating a message to the customer indicating a progress level in relation to the predetermined threshold for initiating a donation.

According to embodiments of the invention, a system for tracking use of an affinity account owned by a customer and organized in accordance with one or more account rules has a processing device configured for receiving information regarding a transaction conducted using an affinity account, the information comprising a transaction amount, determining whether the transaction amount justifies making a donation according to the account rules, initiating, in the event the transaction amount justifies doing so in view of the account rules, a donation according to the account rules, and tracking the transaction amount or the donation resulting from the use of the affinity account.

In some embodiments, tracking the donation comprises storing information regarding the donation. In some such embodiments, storing information regarding the donation comprises storing an amount of the donation. In some such embodiments, storing information regarding the donation comprises storing a recipient of the donation. In some such embodiments, storing information regarding the donation comprises storing a date and time of the donation. In yet other such embodiments, the processing device is further configured for communicating some or all the stored information regarding the donation to the customer.

In some embodiments, the processing device is further configured for communicating information regarding the donation to the customer. In some embodiments, the processing device is further configured for communicating information regarding the donation to a social network of the customer. In some such embodiments, the processing device is further configured for providing a collaboration network comprising one or more users and the customer, the collaboration network configured to provide the one or more users and the customer with an opportunity to collaborate with regard to a common affinity goal, and wherein communicating information regarding the donation to a social network of the customer comprises communicating information regarding the donation to the collaboration network.

In some embodiments, the processing device is further configured for initiating a second donation in addition to the donation as an incentive for the customer to use the affinity account and communicating information regarding the second donation to the customer. In some embodiments, the processing device is further configured for communicating an offer for an incentive donation in the event the customer performs according to the offer. In some such embodiments, communicating an offer comprises communicating an offer for the customer to purchase specific goods or services. In other such embodiments, communicating an offer comprises communicating an offer for the customer to purchase goods or services from a specific merchant.

In some embodiments, communicating information regarding the donation to the customer comprises communicating an offer for an incentive donation in the event the customer performs according to the offer. In some embodiments, tracking the transaction amount comprises tracking two or more transaction amounts and determining that the two or more transaction amounts surpass a predetermined threshold, and the processing device is further configured for initiating the donation according to the account rules and based at least in part on the two or more transaction amounts, in combination, surpassing the predetermined threshold.

In some embodiments, tracking the transaction amount comprises tracking the transaction amount in view of a predetermined threshold for initiating a donation and communicating a message to the customer indicating a progress level in relation to the predetermined threshold for initiating a donation.

According to embodiments of the invention, a computer program product includes a non-transient computer-readable medium having computer-executable instructions for tracking use of an affinity account owned by a customer and organized in accordance with one or more account rules. The instructions include instructions for receiving information regarding a transaction conducted using an affinity account, the information comprising a transaction amount, instructions for determining whether the transaction amount justifies making a donation according to the account rules, instructions for initiating, in the event the transaction amount justifies doing so in view of the account rules, a donation according to the account rules, and instructions for tracking the transaction amount or the donation resulting from the use of the affinity account.

In some such embodiments, the instructions for tracking the donation comprise instructions for storing information regarding the donation. In some of these embodiments, the instructions for storing information regarding the donation comprise instructions for storing an amount of the donation. In other such embodiments, the instructions for storing information regarding the donation comprise instructions for storing a recipient of the donation. In yet other such embodiments, the instructions for storing information regarding the donation comprise instructions for storing a date and time of the donation. In still other such embodiments, the instructions further comprise instructions for communicating some or all the stored information regarding the donation to the customer.

In some embodiments, the instructions further comprise instructions for communicating information regarding the donation to the customer. In some embodiments, the instructions further comprise instructions for communicating information regarding the donation to a social network of the customer. In some such embodiments, the instructions further comprise instructions for providing a collaboration network comprising one or more users and the customer, the collaboration network configured to provide the one or more users and the customer with an opportunity to collaborate with regard to a common affinity goal, and the instructions for communicating information regarding the donation to a social network of the customer comprise instructions for communicating information regarding the donation to the collaboration network.

In some embodiments, the instructions further comprise instructions for initiating a second donation in addition to the donation as an incentive for the customer to use the affinity account and instructions for communicating information regarding the second donation to the customer. In some embodiments, the instructions further comprise instructions for communicating an offer for an incentive donation in the event the customer performs according to the offer. In some such embodiments, the instructions for communicating an offer comprise instructions for communicating an offer for the customer to purchase specific goods or services. In other such embodiments, the instructions for communicating an offer comprise instructions for communicating an offer for the customer to purchase goods or services from a specific merchant.

In some embodiments, the instructions for communicating information regarding the donation to the customer comprise instructions for communicating an offer for an incentive donation in the event the customer performs according to the offer. In some embodiments, the instructions for tracking the transaction amount comprise instructions for tracking two or more transaction amounts and instructions for determining that the two or more transaction amounts surpass a predetermined threshold, and the instructions further comprise instructions for initiating the donation according to the account rules and based at least in part on the two or more transaction amounts surpassing the predetermined threshold. In some embodiments, the instructions for tracking the transaction amount comprise instructions for tracking the transaction amount in view of a predetermined threshold for initiating a donation and instructions for communicating a message to the customer indicating a progress level in relation to the predetermined threshold for initiating a donation.

According to embodiments of the invention, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules, and tracking the transaction amount and the donation resulting from the use of the affinity account. Tracking includes storing information regarding the transaction including an amount of the transaction and storing information regarding the donation including an amount of the donation. The method also includes communicating some or all the stored information regarding the donation to the customer.

In some embodiments, the method also includes communicating some or all the stored information regarding the donation to a social network of the customer. In some such embodiments, the method also includes providing a collaboration network comprising one or more users and the customer, the collaboration network configured to provide the one or more users and the customer with an opportunity to collaborate with regard to a common affinity goal, and wherein communicating information regarding the donation to a social network of the customer comprises communicating information regarding the donation to the collaboration network.

In some embodiments, the method also includes initiating a second donation in addition to the donation as an incentive for the customer to use the affinity account and communicating information regarding the second donation to the customer. In some embodiments, the method also includes communicating an offer for an incentive donation in the event the customer performs according to the offer. In some such embodiments, communicating an offer comprises communicating an offer for the customer to purchase specific goods or services or communicating an offer for the customer to purchase goods or services from a specific merchant. In some embodiments, tracking the transaction amount includes tracking two or more transaction amounts and determining that the two or more transaction amounts surpass a predetermined threshold, and the method also includes initiating the donation according to the account rules and based at least in part on the two or more transaction amounts, in combination, surpassing the predetermined threshold. In some embodiments, tracking the transaction amount comprises tracking the transaction amount in view of a predetermined threshold for initiating a donation and communicating a message to the customer indicating a progress level in relation to the predetermined threshold for initiating a donation.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a flowchart illustrating a method 100 for tracking use of an affinity account owned by a customer and organized in accordance with one or more account rules according to embodiments of the invention;

FIG. 2 is a flowchart illustrating a method 200 including additional steps for tracking use of an affinity account according to embodiments of the invention;

FIG. 3 is a flowchart illustrating a method 300 including additional steps for tracking use of an affinity account according to embodiments of the invention;

FIG. 4 is a flowchart illustrating a method 400 including additional steps for tracking use of an affinity account according to embodiments of the invention;

FIG. 5 is a flowchart illustrating a method 500 including additional steps for tracking use of an affinity account according to embodiments of the invention;

FIG. 6 is a flowchart illustrating a method 600 including additional steps for tracking use of an affinity account according to embodiments of the invention; and

FIG. 7 is a diagram of an environment 700 in which the donation tracking system 701 operates.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As discussed above, affinity accounts, in various instances, may refer to banking accounts, such as demand deposit accounts (DDAs) like checking and/or savings accounts or credit or debit accounts associated with a card or other payment device. The accounts may be considered “affinity” accounts due to an association with an affinity such as an organization, business, non-profit, association or other entity or individual for which some benefit may be bestowed if the owner of the account achieves a predefined goal. For example, in some instances, an affinity account is associated with an affinity of the customer such as a non-profit organization, such as a charitable organization.

In some such instances, the affinity account is organized such that a predetermined threshold of spending using the affinity account triggers an automatic donation to the charitable organization. In various examples, the predetermined threshold may be a relatively low amount or a relatively high amount. In some instances, a donation or other benefit is bestowed on the customer's affinity as a result of every transaction, regarding of the transaction amount, and in other instances, a donation or other benefit is bestowed on the customer's affinity as a result of reaching a threshold after several transaction amounts are summed. In some instances, a group of people are associated and work toward a common goal in order that a donation or other benefit is bestowed on the affinity.

Embodiments of the invention provide transparency into the status of the affinity account as well as any accumulating points, rewards, or credits toward a goal associated with a benefit to be bestowed on the affinity. Accordingly, customers may become more incentivized to use the affinity account and potentially open additional affinity accounts to work towards benefits to other affinities. Similarly, groups of like-minded customers may associate with one another, and based on the additional transparency in the affinity programs provided by embodiments of the invention, may decide to focus their group efforts around one or more affinity programs offered by a financial institution. The affinity account arrangement may be beneficial to the affinity, the financial institution and also should satisfy the customer as he or she is providing benefits to a chosen affinity. In that regard, the affinity program is truly a win-win-win situation.

According to embodiments of the invention, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules and tracking the transaction amount and the donation resulting from the use of the affinity account. In some embodiments, tracking includes storing information regarding the transaction including an amount of the transaction and storing information regarding the donation including an amount of the donation. The method also includes communicating some or all the stored information regarding the donation to the customer.

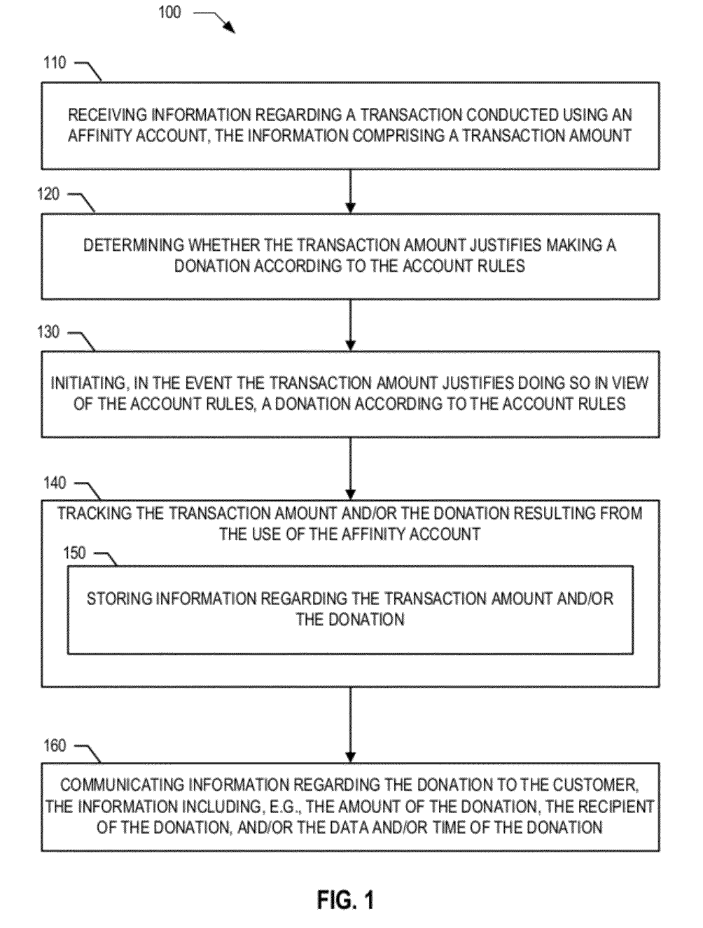

Referring now to FIG. 1, a flowchart illustrates a method 100 for providing a treasury pricing tool according to embodiments of the invention. The first step, as represented by block 110, is receiving information regarding a transaction conducted using an affinity account. In some instances, the information includes a transaction amount. Generally, a customer presents a transaction device to a merchant. The transaction device, as discussed further below, may be a banking card such as a credit or debit card associated with a DDA or some other bank account. The account is associated with an affinity program managed by a financial institution such as a bank. In some instances, the transaction device is branded to indicate an affinity association and a corresponding affinity program managed by the issuer of the transaction device.

As used herein, a “bank account” refers to a credit account, a debit/deposit account, or the like. Although the phrase “bank account” includes the term “bank,” the account need not be maintained by a bank and may, instead, be maintained by other financial institutions. As used herein, unless specifically limited by the context, a “transaction” may refer to a purchase of goods or services, a return of goods or services, a payment transaction, a credit transaction, or other transaction involving the consumer's bank account. As used herein, the term “products” refers to both goods and services.

A “transaction device” as used herein refers to any device used by the consumer to transfer or point to information useful to the vendor during a transaction proximate a point of sale. The term is intended to be read broadly to include many different types of devices such as loyalty devices, mobile devices, payment devices, and any other devices carried by a consumer during a transaction proximate a point of sale. When used herein, the term “payment device” is used synonymously with “transaction device” and is intended to include not only payment devices but also any other type of transaction devices as defined above. Examples of transaction or payment devices as used herein include, but are not limited to, loyalty devices such as loyalty cards or other loyalty devices, magnetic-based payment devices such as credit cards, debit cards, and the like, personal identification number (PIN) payment devices, contactless payment devices such as key fobs, radio frequency identification devices (RFID) and the like, and mobile devices such as smartphones, cellular phones, personal digital assistant (PDA) devices, MP3 devices, personal GPS devices and the like.

The next step, as represented by block 120, is determining whether the transaction amount justifies making a donation according to account rules. The affinity account is associated with an affinity program managed by the financial institution. In some instances, the affinity program has a set of rules by which the affinity program is operated. Such rules correspond to a set of account rules by which the specific affinity account owned by the customer is managed. For example, in one embodiment, the affinity program has a set of rules dictating cumulative purchase thresholds of $1000.00 increments in order to warrant a benefit bestowed on the affinity associated with the affinity account. The rules of the affinity program correspond to a set of account rules configured to manage the affinity account. In the example above, the account rules may dictate that a message is communicated by the financial institution server involved in one or more transactions associated with the affinity account to an affinity server also maintained by the financial institution. The message may include information regarding the transaction such as the transaction amount as illustrated by block 110 discussed above. The affinity server or other processing device configured for receiving the information regarding the transaction then determines whether the transaction amount surpasses the predetermined threshold or other criteria dictated by the account rules. In the example above, the customer's previous transaction amounts are summed in addition to the current transaction amount to determine whether the summed amount surpasses the predetermined threshold of $1000.00.

The next step, as represented by block 130, is initiating a donation according to the account rules in the event the transaction amount justifies doing so. As discussed above, the determination is made whether the transaction amount justifies initiating the transaction in step 120. If so, the processing device, such as a financial server or affinity server, initiates a donation or initiates bestowing of some other benefit as dictated by the rules associated with the affinity program. For example, a benefit may be bestowed such as frequent flier miles, cash rewards, rewards points, or some other benefit to the customer's affinity. The customer's affinity, in various embodiments, is a person related to the customer, such as the customer's spouse, parent or child.

In some embodiments, once a donation or other benefit has been bestowed, the next benefit to be bestowed is calculated based on a non-linear scale, for example, a donation is made at $1000.00, another at $1500.00 and another at $1750.00 worth of purchases made using the affinity account. In some embodiments, the donation amount changes based on the product(s) the customer is purchasing with the affinity account, and in some embodiments, the donation amount changes based on the level of transaction amount. For example, for a $1000.00 purchase, a donation of 5% is made, whereas when the transaction amount is $50,000.00, a donation of 3% is made. As another example, in some embodiments, the donation amount is determined not based on percentage of transaction amount but rather as a fixed amount upon the customer's transactions rising above a predetermined threshold. In some embodiments, the donation is made based on the specific goods and/or services being purchased by the customer. In this regard, the financial institution may implement a program in association with the affinity program to entice the customer to purchase one or more specific products by offering different or perceptibly better benefits to the customer's affinity. In some embodiments, financial institution may contract with a product seller in order that that product will be offered greater than usual affinity program benefits, thereby enticing the customer to purchase specific products.

The next step, as represented by block 140 is tracking the transaction amount and/or the donation resulting from the use of the affinity account. In some instances, the transaction amount was determined not to be sufficient to justify making a donation or bestowing some other benefit as discussed above with reference to blocks 120 and 130. In such situations, the transaction amount may be tracked. In some embodiments, step 140 includes a sub-step, as represented by block 150, of storing information regarding the transaction amount and/or information regarding the donation or other bestowed benefit. In circumstances such as the example discussed above, the transaction amount may be stored for retrieval proximate in time to the next transaction involving the affinity account. In this regard, the system can, in view of the stored information regarding the transaction amount, make a determination with regard to whether a new transaction amount justifies making a donation or otherwise bestowing a benefit on the affinity of the customer.

In instances where the transaction amount, either by itself or in combination with one or more other transaction amounts associated with the affinity account of the same customer or other customers participating in an affinity group, justifies initiating a donation, the system stores information regarding the donation, such as the donation amount, the donation recipient, the donation date and/or time.

The last step, as represented by block 160 is communicating information regarding the donation to the customer. In some embodiments, the information includes, for example, the amount of the donation, the recipient of the donation, and/or the data and/or time of the donation. Thus, a level of transparency is provided to the customer so that the customer is aware that the donation occurred when a particular transaction was completed and/or when a particular threshold was surpassed. In some embodiments, the system communicates additional information to the customer such as the status of the accumulation of transaction amounts, which are alternatively stored as points or some other representative item. In this regard, the customer is aware of the accumulation of transaction amounts. In some embodiments, the system also communicates information related to the goals of the customer and/or the customer's affinity group. For example, the system may communicate that the next donation to the customer's affinity occurs when the customer has made $500.00 worth of additional purchases using the affinity account and that the amount of the potential donation is $10.00. As another example, in instances where the customer belongs to an affinity group working towards common goals, the system may communicate messages to the customer individually or to the entire group regarding the status of accumulation toward a goal and information regarding the nature of the benefit to the affinity should the goal be achieved.

In some embodiments, the charity or receiving entity is queried regarding its present needs. A goal may be dynamically created in conjunction with the receiving entity in order to meet the receiving entity's most dire needs. In addition, progress toward the goal may also be communicated to the receiving entity, and in some instances, to the affinity group as well, so that an element of accountability is added. For example, a charity that is the target of an affinity group may be contacted regarding its current needs. The charity may be in need of fifty wheelchairs, and thus communicates that need to the affinity group. As the affinity group works toward reaching the goal, the charity is notified periodically of the progress.

In various embodiments, feedback regarding the nature of the customer's contribution, such as a donation, may be communicated to the customer once the donation has been made and after the donation has been applied by the receiving entity. For example, in one embodiment, the receiving entity is a soup kitchen and the donation is applied to purchase ingredients for soup for feeding impoverished people. Once the donation has been applied by the soup kitchen, the customer is notified of the actual effect of the donation. In various embodiments, communications regarding the nature of the application of the donation are initiated in varying periodic time frames, such as monthly, quarterly, bi-annually, or annually. In various other embodiments, communications regarding the nature of the application of the donation are pushed on demand, such as, proximal in time to the application of the donation by the receiving entity.

In some embodiments, the donation amount is a rider on the transaction itself. For example, in one embodiment, the affinity account is configured such that a predetermined donation amount or percentage is added to the transaction amount for every transaction. In other embodiments, the donation amount is added to the transaction amount only for specific transactions. For example, the donation amount may be added to the transaction amount only for transactions involving a predetermined class of goods and/or services or specific goods and/or services or only goods and/or services purchased from one or more predetermined merchants. In these embodiments, step 120 includes determining whether the nature or character of the transaction justifies making the donation according to the pre-established account rules. In some embodiments, the determination includes determining that every transaction amount justifies making a donation as discussed in the example above. In other embodiments, the determination includes on making a donation when the transaction satisfies the predetermined rules, such as, for example, the transaction being characterized as an electronics purchase.

In these embodiments, step 130 includes initiating the predetermined donation amount in the event the transaction satisfies the account rules. For example, if the transaction is characterized in a fashion commiserate with the account rules, such as an electronics purchase, then, in some embodiments, the donation amount is automatically added to the transaction amount during the transaction itself. In other embodiments, the donation amount is added to the transaction amount at a later time, and in yet other embodiments, the donation amount is not added to the transaction amount but is considered a separate transaction.

In these embodiments, step 140 includes tracking the donation resulting from the use of the affinity account similarly to that discussed above. In some instances, however, the customer may be unaware that a particular class of purchase, for example, resulted in a donation. In such instances, the customer may be informed of this via the communication of step 160.

In some embodiments, the donation amount is drawn from the customer's affinity account funds, and in other embodiments, the donation amount is drawn from one or more of the customer's other accounts with the same financial institution managing the affinity account and/or another financial institution. In some embodiments, the donation amount is drawn from an account other than the customer's account. For example, the donation amount may be drawn from an account owned by the financial institution managing the affinity program.

In some embodiments, the affinity program has been arranged with particular merchants, manufacturers or others within the product chain in order that the price of the product(s) being purchased have been reduced such that the customer utilizing the affinity account does not pay an additional donation amount during the transaction, but rather, the customer pays the same price for the product(s) as any other customer. However, in this example, a portion of the transaction amount is donated to the affinity of the customer's choice. In this regard, the customer is provided an incentive to purchase the product(s) for which there will be a donation, especially considering the lack of increase in price. In some other embodiments, the financial institution may even negotiate a price below market value and also include a donation to the customer's affinity. Embodiments of the invention, among other things, provide the customer vision into the donations actually taking place as well as information regarding the types and quantities of transactions resulting in donations.

In some embodiments, an entity within the chain of distribution for goods, such as a retailer or manufacturer, is making a donation based on user behavior. One or more of those entities within the distribution chain can communicate with the account holder in order to provide vision into the end result of the donation being made. For example, if the retailer donates to a specific local charity, the retailer can send a communication to the user detailing the amount of the donation, and for example, that the donation was used to purchase cleaning supplies for a local charity.

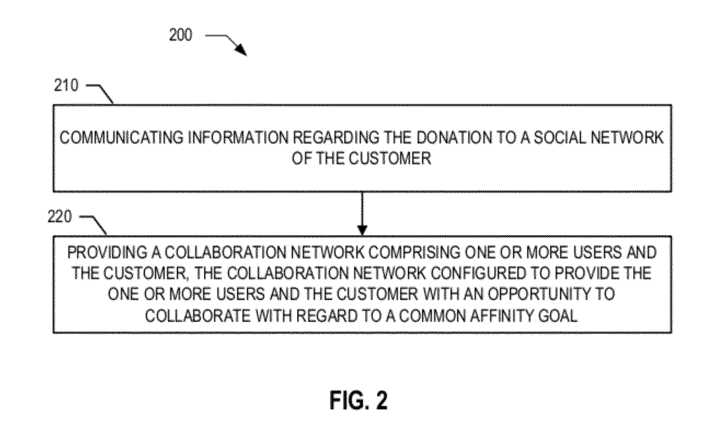

Referring to FIG. 2, a flowchart illustrates a method 200 including various steps, each of which may or may not be included with the one or more of the steps of method 100 illustrated in FIG. 1 according to various embodiments of the invention. The first step, as represented by block 210, is communicating information regarding the donation to a social network of the customer. In various embodiments, the social network may be or include facebook, twitter, myspace, linkedin or some other social network. In some embodiments, the social network includes or is an affinity group or network of people having a common goal.

The next step, as represented by block 220, is providing a collaboration network. In some embodiments, the collaboration network includes one or more users and the customer. The collaboration network, in various embodiments, is configured to provide the one or more users and the customer with an opportunity to collaborate with regard to a common affinity goal. For example, in some instances, a collaboration network may be established by a group of like-minded people interested in raising funds for a specific charitable organization. In this example, the people participating in the group may open affinity account linked together by the financial institution such that the purchases made using the various affinity accounts are summed in order to determine progress toward the common goal. In various embodiments, the collaboration network is configured similar to other social networks such that the participants may communicate with one another through various media such as message boards, blogs, real time chatting, messaging and the like.

In various embodiments, the collaboration network is configured by the participants to include a unique set of collaboration network rules configured for dictating the affinity program management. For example, at what thresholds benefits will be bestowed on the affinity. In some embodiments, the collaboration network rules are based in part on a predetermined set of affinity program rules set forth by the financial institution offering the collaboration network opportunity. For example, the collaboration network may be allowed to set particular thresholds for benefits to be bestowed to the chosen affinity of the collaboration network, however, the amounts or levels of benefits are dictated by predetermined affinity program rules. For example, the network may choose to set a goal at $500.00, and the donation would be dictated by the rules established by the financial institution at $25.00. If the network had chosen $1000.00, however, the donation dictated by the financial institution would be $65.00, which is a better percentage of the overall transaction accumulation amount.

In various embodiments, the collaboration network is formed by a group of individuals dynamically coming together to form an affinity where the terms and conditions of the affinity are negotiated in real-time by intelligent agents or artificial intelligence agents. For example, a customer and his friends want to start an affinity to support a target organization, such as an affinity designed to support global viral forecasting (gvfi.org). Once a predetermined threshold of users indicate a desire to participate in the affinity, such as through Facebook.com or some other social media network and, in some instances, commit their account to such an effort, the issuer engages the target organization to work on terms and conditions of the arrangement. The terms and conditions can be a template and then may be customized. Once the participants agree upon the terms and conditions, an automated application takes over in order to complete the affinity creation and implementation.

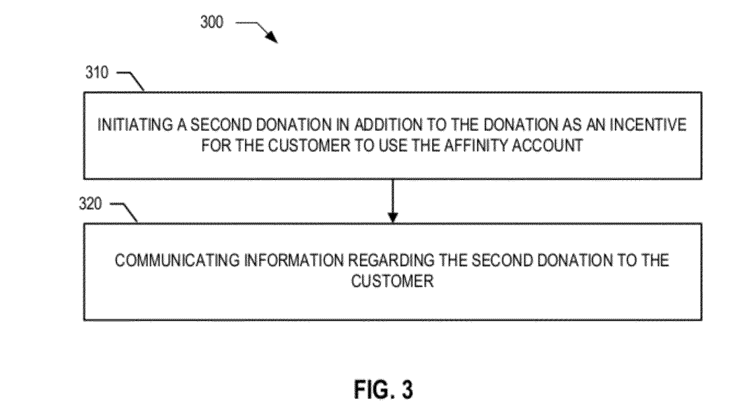

Referring now to FIG. 3, a flowchart illustrates a method 300 including steps, each of which may or may not be included with one or more of the steps of method 100 and/or method 200 illustrated in FIGS. 1 and 2, respectively, according to various embodiments of the invention. The first step, as represented by block 310 is initiating a second donation in addition to the original donation as an incentive for the customer to use the affinity account. As discussed above, in some affinity programs, the customer will achieve multiple goals at different levels of transaction amount. In this regard, the customer is provided an incentive for continuing to use the affinity account even after achieving a goal. In fact, the customer may be further motivated by the fact that a goal was achieved, a donation or other benefit was bestowed, and the system has communicated such information indicating this to the customer.

The next step, as illustrated by block 320, is communicating information regarding the second donation to the customer. Further to the discussion above, information regarding a second donation or other benefit bestowed on the customer's chosen affinity may entice the customer to continue using the affinity account for purchases or other transactions. In various embodiments, every donation or benefit bestowed on the customer's chosen affinity is communicated to the customer so that the customer will be cognizant of he impact the customer's spending behavior is having on the affinity. In some embodiments, the system also receives feedback from the affinity in order to communicate some or all the feedback to the customer so that the customer may have additional incentive to continue using the affinity account for purchases.

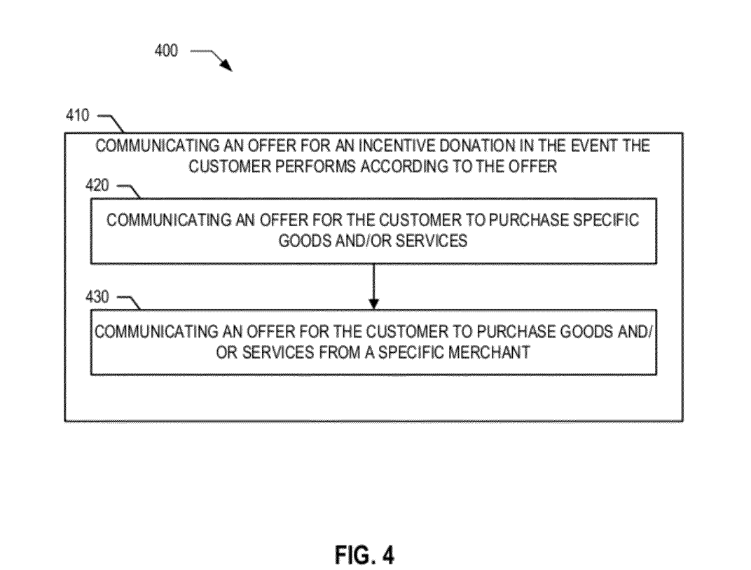

Referring now to FIG. 4, a flowchart illustrates a method 400 including steps, each of which may or may not be included with some or all the steps of method 100, method 200, method 300 and/or other steps according to various embodiments of the invention. As represented by block 410, the first and only step is communicating an offer for an incentive donation in the event the customer performs according to the offer. In various embodiments, step 410 includes one or more sub-steps, such as sub-steps represented by blocks 420 and 430.

In block 420, an offer is communicated for the customer to purchase specific goods and/or services. The offer may be, in various embodiments, an offer to purchases goods and/or services for which the financial institution managing the affinity account has negotiated a kickback payment or some other arrangement that is mutually beneficial to the financial institution and the merchant, manufacturer or other entity in the product chain of the goods and/or services. In some embodiments, the offer may include incentives for the customer to purchase the specific goods and/or services, such as, for example, an added donation or other benefit to be bestowed in the event the customer performs according to the offer and purchases the specific goods and/or services. Similarly, in block 430, an offer is communicated for the customer to purchase goods and/or services from a specific merchant. The financial institution, for example, may have a negotiated arrangement with the merchant that provides some mutual benefits. Likewise, the offer may provide the customer an opportunity for an otherwise unavailable discount and/or an opportunity to achieve an affinity program donation or other benefit for the customer's chosen affinity.

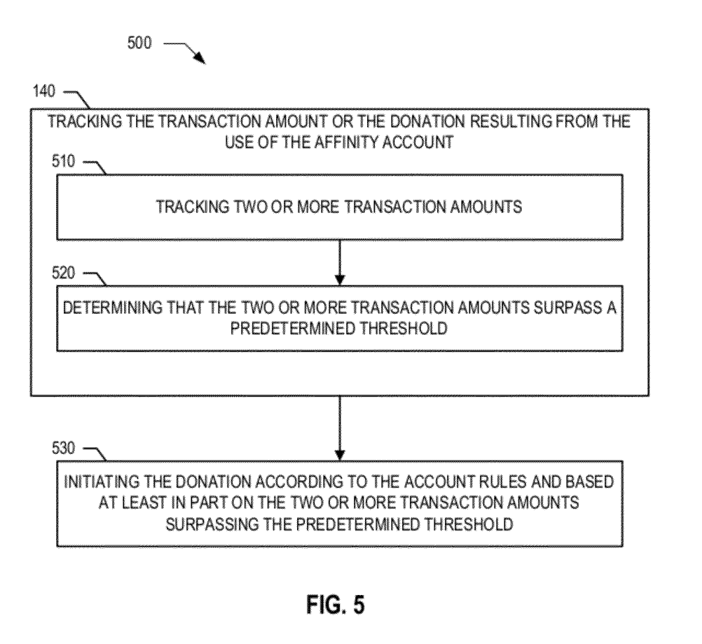

Referring now to FIG. 5, a flowchart illustrates a method 500 including steps, each of which may or may not be included with some or all the steps of the various methods discussed herein and/or other steps according to various embodiments of the invention. The first step, as represented by block 140, and initially presented in FIG. 1, is tracking the transaction amount or the donation resulting from the use of the affinity account. In some embodiments, step 140 includes sub-steps such as those represented by blocks 510 and 520.

As represented by block 510, the first sub-step is tracking two or more transaction amounts. In tracking two or more transaction amounts, the system may determine an accumulated transaction amount and then compare that amount to one or more predetermined thresholds in order to determine whether a donation or other benefit is in order. As represented by block 520, the next sub-step is determining that the two or more transaction amounts surpass a predetermined threshold. The next step in method 500, as represented by block 530, is initiating the donation according to the account rules and based at least in part on the two or more transaction amounts surpassing the predetermined threshold.

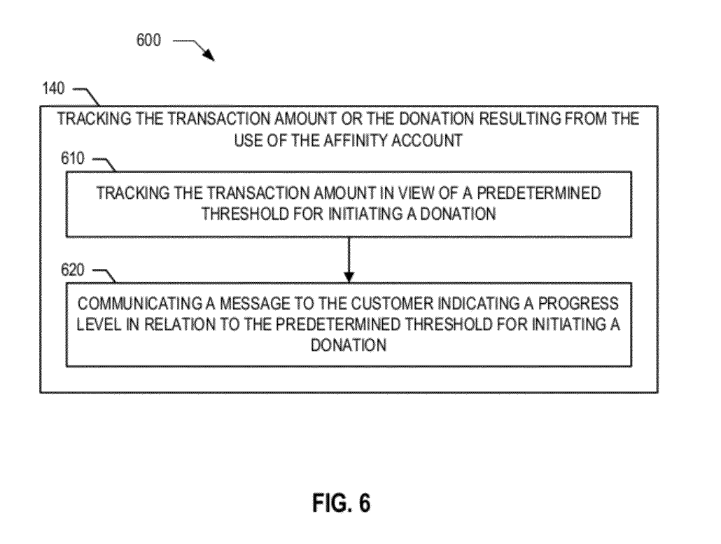

Referring now to FIG. 6, a flowchart illustrates a method 600 including steps, each of which may or may not be included with some or all the steps of the various methods discussed herein and/or others steps according to various embodiments of the invention. The method includes step 140, which was first presented in FIG. 1, where the processing device tracks the transaction amount or the donation resulting from the use of the affinity account. In some embodiments, step 140 includes one or more sub-steps, such as sub-steps represented by blocks 610 and 620. As represented by block 610, the first sub-step is tracking the transaction amount in view of a predetermined threshold for initiating a donation. The system tracks the transaction amount, and in some embodiments adds the transaction amount with one or more previous transaction amounts in order to track an accumulated transaction amount. This amount is compared to a predetermined threshold amount for initiating a donation or other benefit. In some embodiments. As represented by block 620, the next sub-step is communicating a message to the customer indicating a progress level in relation to the predetermined threshold for initiating a donation. Thus, the system communicates to the customer information useful for motivating the customer to continue using the affinity account for purchases. This motivation appeals to social norms as well as a sense of reciprocity, that is, that the customer is working toward a cognizable goal and is aware of the impact of certain actions in view of reaching that goal. Therefore, the customer continues accumulating transaction amounts and thereby achieves the predetermined threshold and the donation or other benefit.

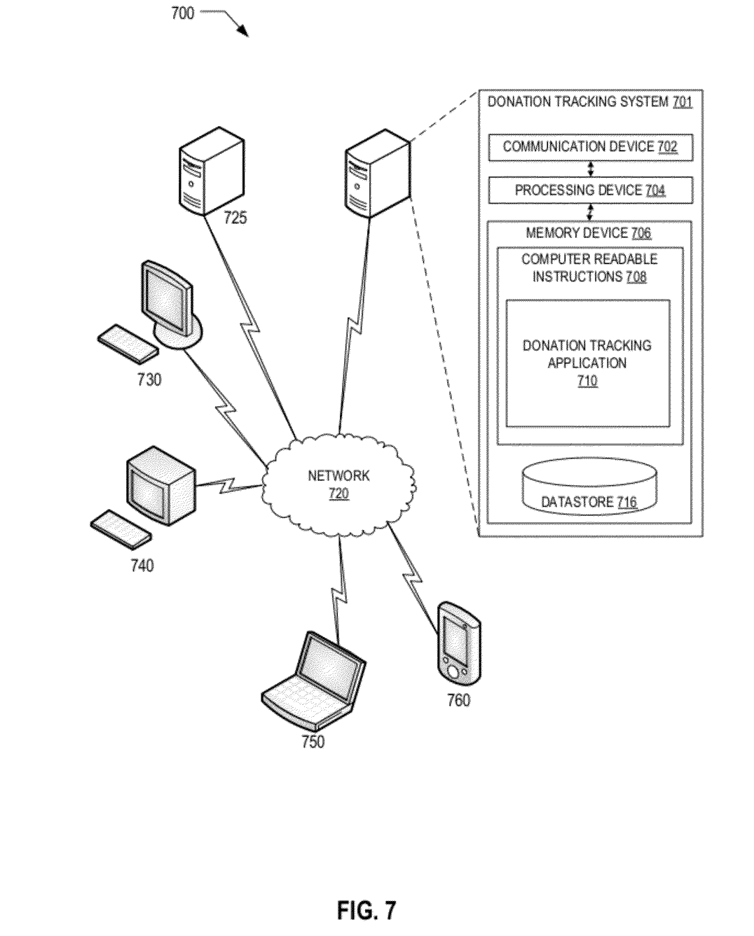

Referring now to FIG. 7, an environment 700 in which a donation tracking system 701 operates is illustrated. The donation tracking system 701 may, in various embodiments be configured for performing one or more of the steps discussed with regard to one or more of methods 100, 200, 300, 400, 500 and/or 600 including or excluding one or more of the various steps disclosed above. In the configuration shown, the donation tracking system 701 communicates across a network 720 with one or more other systems, such as system 725, other servers, remote devices, such as workstation 740, workstation 730, laptop 750 and/or handheld device 760. This configuration is intended to illustrate that a customer or other user (not shown) can interact with the donation tracking system 701 using a variety of devices remote to the donation tracking system 701. Furthermore, in some embodiments one or more customers can interact with the donation tracking system 701 locally such as through an input/output device attached directly with the donation tracking system 701.

In some embodiments, the system 725 represents one or more financial institution servers configured to communicate across the network with one or more other servers, thereby forming a banking network configured to process transaction such as those discussed herein. The system 725, in some embodiments is also configured for communicating with the donation tracking system 701, which in various embodiments, may or may not be maintained by the same financial institution that maintains one or more of the servers and/or other systems represented by system 725. In some embodiments, the system 725 is or includes the donation tracking system 701, and in some embodiments the donation tracking system 701 is or includes the system 725. In some embodiments, the system 725, representing one or more components or systems of the financial institution and transaction network, communicates information regarding one or more transactions and/or one or more donations or benefits associated with the one or more transactions to the donation tracking system 701. The donation tracking system 701, as indicated in step 110 of FIG. 1, receives the information from the system 725. In some embodiments, the system 725 communicates information to the donation tracking system 701 and awaits instructions regarding whether to proceed with a donation and/or bestow other benefit(s). In some such embodiments, the donation tracking system 701 makes a determination regarding the donation or other benefit and then communicates the decision across the network 720 to the system 725. The system 725, in some embodiments, immediately initiates the donation during or immediately after the transaction has closed. In some embodiments where the system 725 is or include the donation tracking system 701, the communication occurs internally to the system 725 or 701. In some embodiments the customer interacts with the system 725 directly without requiring the network 720. For example, the customer presents a transaction device such as a payment device at a point of sale owned by a merchant. The customer initiates payment for a purchase using the point of sale and through the payment device. The merchant point of sale, which is either part of the system 725 or is connected with the system 725 across the network 720 then communicates with the donation tracking system 701 information regarding the transaction. In various embodiments, the transaction device associated with the affinity account, such as a bank card or smart card, includes data presenting instructions for the point of sale to communicate with the donation tracking system 701 in order to determine whether a donation is appropriate. In some embodiments, the transaction device, such as, for example, a mobile device 760, includes data presenting instructions for the point of sale to initiate a donation based on rules also included in the data stored by the transaction device.

The donation tracking system 701, in various embodiments, has a communication device 702 controlled by a processing device 704 configured to communicate across the network 720. The network 720 is an intranet, the Internet, a local area network, a wide area network, and/or any other electronic device network, and/or any combination of the same. The processing device 704 is also in communication with a memory device 706 configured for storing computer-readable and computer-executable instructions 708. The computer-readable instructions, in various embodiments, include one or more applications, such as a donation tracking application 710.

Generally, in some embodiments, some, all or none of the method steps and/or sub-steps discussed above with reference to FIGS. 1, 2, 3, 4, 5, and/or 6 are embodied in computer-executable instructions within the donation tracking application 710. In some embodiments, one or more applications are contained within one application, and in other embodiments, the instructions for executing the donation tracking application are spread over two or more applications. In some embodiments, some of the instructions for executing the donation tracking application are stored on the donation tracking system 701 and some of the instructions are stored on a customer device, such as a transaction device, other mobile device or workstation or server. In some embodiments, some or all the instructions are stored remotely from the donation tracking system 701 and accessed as necessary by the donation tracking system 701 and/or any other device requiring instructions. Further, in some embodiments, the memory device 706 includes a datastore 716 configured for storing instructions, information and/or data such as the account rules configured for managing the accounts associated with affinity programs. In some embodiments, the datastore 716 is also configured for storing information and/or data such as one or more tables including entries associated with a plurality of affinity programs and their associated affinity rules or other instructions or data associated with the various programs. In other embodiments, the datastore 716 is housed remotely from the donation tracking system 701 and the donation tracking system 701 is in communication with the datastore 716 across the network 720 and/or across some other communication link.

In some embodiments one or more additional systems or servers are configured for communicating with the donation tracking system 701. In some such embodiments, information regarding different customers may be stored in various locations on different systems. In some embodiments, information regarding one customer's financial accounts, affinity accounts, and/or group affinity accounts may be stored on separate systems or datastores. In some embodiments, a donation tracking system 701 functions as a central control server and accesses the various pieces of information, data and/or instructions from various locations, thereafter presenting it to the customer and/or performing the processes associated with the instructions using a processing device and/or other system components shown in FIG. 7 or otherwise. In various other embodiments, multiple servers or systems functions together as a central control server and access different pieces of data and/or instructions in order to perform one or more of the steps discussed above.

In summary, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules and tracking the transaction amount and the donation resulting from the use of the affinity account. In some embodiments, tracking includes storing information regarding the transaction including an amount of the transaction and storing information regarding the donation including an amount of the donation. The method also includes communicating some or all the stored information regarding the donation to the customer.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1. A method for tracking use of an affinity account owned by a customer and organized in accordance with one or more account rules, the method comprising:
receiving, using a processing device configured to receive, information regarding a transaction conducted using an affinity account, the information comprising a transaction amount;
determining, using a processing device configured to determine, whether the transaction amount justifies making a donation according to the account rules;
initiating, using a processing device configured to initiate in the event the transaction amount justifies doing so in view of the account rules, a donation according to the account rules;
tracking, using a processing device configured to track, the transaction amount or the donation resulting from the use of the affinity account;
providing a collaboration network comprising one or more users and the customer, the collaboration network configured to provide the one or more users and the customer with an opportunity to collaborate with regard to a common affinity goal;
linking a plurality of collaboration affinity accounts including the affinity account owned by the customer and one or more affinity accounts owned by the one or more users such that transactions associated with the collaboration affinity accounts are summed to determine progress toward a common collaboration goal; and
initiating communication, using a processing device configured to initiate communication, of information regarding the donation to the collaboration network.

2. The method of claim 1, wherein tracking the donation comprises storing information regarding the donation.

3. The method of claim 2, wherein storing information regarding the donation comprises storing an amount of the donation.

4. The method of claim 2, wherein storing information regarding the donation comprises storing a recipient of the donation.

5. The method of claim 2, wherein storing information regarding the donation comprises storing a date and time of the donation.

6. The method of claim 2, further comprising:
communicating some or all the stored information regarding the donation to the customer.

7. The method of claim 1, further comprising:
communicating information regarding the donation to the customer.

8. The method of claim 1, further comprising:
communicating information regarding the donation to a social network of the customer.

9. (canceled)

10. The method of claim 1, further comprising:
initiating a second donation in addition to the donation as an incentive for the customer to use the affinity account; and
communicating information regarding the second donation to the customer.

11. The method of claim 1, further comprising:
communicating an offer for an incentive donation in the event the customer performs according to the offer.

12. The method of claim 11, wherein communicating an offer comprises communicating an offer for the customer to purchase specific goods or services.

13. The method of claim 11, wherein communicating an offer comprises communicating an offer for the customer to purchase goods or services from a specific merchant.

14. The method of claim 7, wherein communicating information regarding the donation to the customer comprises communicating an offer for an incentive donation in the event the customer performs according to the offer.

15. The method of claim 1, wherein tracking the transaction amount comprises:
tracking two or more transaction amounts; and
determining that the two or more transaction amounts surpass a predetermined threshold, the method further comprising:
initiating the donation according to the account rules and based at least in part on the two or more transaction amounts, in combination, surpassing the predetermined threshold.

16. The method of claim 1, wherein tracking the transaction amount comprises:
tracking the transaction amount in view of a predetermined threshold for initiating a donation; and
communicating a message to the customer indicating a progress level in relation to the predetermined threshold for initiating a donation.

17. A system for tracking use of an affinity account owned by a customer and organized in accordance with one or more account rules, the system comprising a processing device configured for:
receiving information regarding a transaction conducted using an affinity account, the information comprising a transaction amount;
determining whether the transaction amount justifies making a donation according to the account rules;
initiating, in the event the transaction amount justifies doing so in view of the account rules, a donation according to the account rules;
tracking the transaction amount or the donation resulting from the use of the affinity account;
providing a collaboration network comprising one or more users and the customer, the collaboration network configured to provide the one or more users and the customer with an opportunity to collaborate with regard to a common affinity goal;
linking a plurality of collaboration affinity accounts including the affinity account owned by the customer and one or more affinity accounts owned by the one or more users such that transactions associated with the collaboration affinity accounts are summed to determine progress toward a common collaboration goal; and
initiating communication of information regarding the donation to the collaboration network.

18. The system of claim 17, wherein tracking the donation comprises storing information regarding the donation.

19. The system of claim 18, wherein storing information regarding the donation comprises storing an amount of the donation.

20. The system of claim 18, wherein storing information regarding the donation comprises storing a recipient of the donation.

21. The system of claim 18, wherein storing information regarding the donation comprises storing a date and time of the donation.

22. The system of claim 18, wherein the processing device is further configured for:
communicating some or all the stored information regarding the donation to the customer.

23. The system of claim 17, wherein the processing device is further configured for:
communicating information regarding the donation to the customer.

24. The system of claim 17, wherein the processing device is further configured for:
communicating information regarding the donation to a social network of the customer.

25. (canceled)

26. The system of claim 17, wherein the processing device is further configured for:
initiating a second donation in addition to the donation as an incentive for the customer to use the affinity account; and
communicating information regarding the second donation to the customer.

27. The system of claim 17, wherein the processing device is further configured for:
communicating an offer for an incentive donation in the event the customer performs according to the offer.

28. The system of claim 27, wherein communicating an offer comprises communicating an offer for the customer to purchase specific goods or services.

29. The system of claim 27, wherein communicating an offer comprises communicating an offer for the customer to purchase goods or services from a specific merchant.

30. The system of claim 23, wherein communicating information regarding the donation to the customer comprises communicating an offer for an incentive donation in the event the customer performs according to the offer.

31. The system of claim 17, wherein tracking the transaction amount comprises:
tracking two or more transaction amounts; and
determining that the two or more transaction amounts surpass a predetermined threshold, the processing device further configured for:
initiating the donation according to the account rules and based at least in part on the two or more transaction amounts, in combination, surpassing the predetermined threshold.

32. The system of claim 17, wherein tracking the transaction amount comprises:
tracking the transaction amount in view of a predetermined threshold for initiating a donation; and
communicating a message to the customer indicating a progress level in relation to the predetermined threshold for initiating a donation.

33. A computer program product comprising a non-transient computer-readable medium comprising computer-executable instructions for tracking use of an affinity account owned by a customer and organized in accordance with one or more account rules, the instructions comprising:
instructions for receiving information regarding a transaction conducted using an affinity account, the information comprising a transaction amount;
instructions for determining whether the transaction amount justifies making a donation according to the account rules;
instructions for initiating, in the event the transaction amount justifies doing so in view of the account rules, a donation according to the account rules;
instructions for tracking the transaction amount or the donation resulting from the use of the affinity account;
instructions for providing a collaboration network comprising one or more users and the customer, the collaboration network configured to provide the one or more users and the customer with an opportunity to collaborate with regard to a common affinity goal;
instructions for linking a plurality of collaboration affinity accounts including the affinity account owned by the customer and one or more affinity accounts owned by the one or more users such that transactions associated with the collaboration affinity accounts are summed to determine progress toward a common collaboration goal; and
instructions for initiating communication of information regarding the donation to the collaboration network.

34. The computer program product of claim 33, wherein the instructions for tracking the donation comprise instructions for storing information regarding the donation.

35. The computer program product of claim 34, wherein the instructions for storing information regarding the donation comprise instructions for storing an amount of the donation.

36. The computer program product of claim 34, wherein the instructions for storing information regarding the donation comprise instructions for storing a recipient of the donation.

37. The computer program product of claim 34, wherein the instructions for storing information regarding the donation comprise instructions for storing a date and time of the donation.

38. The computer program product of claim 34, wherein the instructions further comprise:
instructions for communicating some or all the stored information regarding the donation to the customer.

39. The computer program product of claim 33, wherein the instructions further comprise:
instructions for communicating information regarding the donation to the customer.

40. The computer program product of claim 33, wherein the instructions further comprise:
instructions for communicating information regarding the donation to a social network of the customer.

41. (canceled)

42. The computer program product of claim 33, wherein the instructions further comprise:
instructions for initiating a second donation in addition to the donation as an incentive for the customer to use the affinity account; and
instructions for communicating information regarding the second donation to the customer.

43. The computer program product of claim 33, wherein the instructions further comprise:
instructions for communicating an offer for an incentive donation in the event the customer performs according to the offer.

44. The computer program product of claim 43, wherein the instructions for communicating an offer comprise instructions for communicating an offer for the customer to purchase specific goods or services.

45. The computer program product of claim 43, wherein the instructions for communicating an offer comprise instructions for communicating an offer for the customer to purchase goods or services from a specific merchant.

46. The computer program product of claim 39, wherein the instructions for communicating information regarding the donation to the customer comprise instructions for communicating an offer for an incentive donation in the event the customer performs according to the offer.

47. The computer program product of claim 33, wherein the instructions for tracking the transaction amount comprise:
instructions for tracking two or more transaction amounts; and
instructions for determining that the two or more transaction amounts surpass a predetermined threshold, the instructions further comprising:
instructions for initiating the donation according to the account rules and based at least in part on the two or more transaction amounts surpassing the predetermined threshold.

48. The computer program product of claim 33, wherein the instructions for tracking the transaction amount comprise:
instructions for tracking the transaction amount in view of a predetermined threshold for initiating a donation; and
instructions for communicating a message to the customer indicating a progress level in relation to the predetermined threshold for initiating a donation.

49. A method for tracking use of an affinity account owned by a customer and organized in accordance with one or more account rules, the method comprising:
receiving, using a processing device configured to receive, information regarding a transaction conducted using an affinity account, the information comprising a transaction amount;
determining, using a processing device configured to determine, whether the transaction amount justifies making a donation according to the account rules;
determining, using a processing device configured to determine, that the transaction amount justifies a donation according to the account rules;
initiating, using a processing device configured to initiate, a donation according to the account rules; and
tracking, using a processing device configured to track, the transaction amount and the donation resulting from the use of the affinity account, the tracking comprising:
storing information regarding the transaction including an amount of the transaction; and
storing information regarding the donation including an amount of the donation; and wherein the method further comprises:
providing a collaboration network comprising one or more users and the customer the collaboration network configured to provide the one or more users and the customer with an opportunity to collaborate with regard to a common affinity goal;
linking a plurality of collaboration affinity accounts including the affinity account owned by the customer and one or more affinity accounts owned by the one or more users such that transactions associated with the collaboration affinity accounts are summed to determine progress toward a common collaboration goal;
initiating communication, using a processing device configured to initiate communication, of information regarding the donation to the collaboration network; and
communicating, using a processing device configured to communicate some or all the stored information regarding the donation to the customer.

50. The method of claim 49, further comprising:
communicating some or all the stored information regarding the donation to a social network of the customer.

51. (canceled)

52. The method of claim 49, further comprising:
initiating a second donation in addition to the donation as an incentive for the customer to use the affinity account; and
communicating information regarding the second donation to the customer.

53. The method of claim 49, further comprising:
communicating an offer for an incentive donation in the event the customer performs according to the offer.

54. The method of claim 53, wherein communicating an offer comprises communicating an offer for the customer to purchase specific goods or services or communicating an offer for the customer to purchase goods or services from a specific merchant.

55. The method of claim 49, wherein tracking the transaction amount comprises:
tracking two or more transaction amounts; and
determining that the two or more transaction amounts surpass a predetermined threshold, the method further comprising:
initiating the donation according to the account rules and based at least in part on the two or more transaction amounts, in combination, surpassing the predetermined threshold.

56. The method of claim 49, wherein tracking the transaction amount comprises:
tracking the transaction amount in view of a predetermined threshold for initiating a donation; and
communicating a message to the customer indicating a progress level in relation to the predetermined threshold for initiating a donation.
